(19) United States
(12) Patent Application Publication
(10) Pub. No.: US 2007/0174276 A1
(43) Pub. Date: Jul. 26, 2007

(54) Thematic grouping of program segments

(75) Inventors: Marc Sullivan, Austin, TX (US); Brandt Jeff, Cedar Park, TX (US)

Correspondence Address: SCHWEGMAN, LUNDBERG, WOESSNER & KLUTH, P.A., P.O. BOX 2938, MINNEAPOLIS, MN, 55402, US

(73) Assignee: SBC Knowledge Ventures, L.P.

(21) Appl. No.: 11/339,223

(22) Filed: Jan. 24, 2006

(51) Int. Cl. G06F 7/00

(52) U.S. Cl. 707/7

(57) ABSTRACT

Program segments are grouped by theme. A program includes different program segments, each program segment being associated with at least one theme indicated by associated metadata. The program is queried to determine whether the program segments include a particular theme. Each of the program segments that have the particular theme are grouped together.

### FIELD

This application relates generally to the field of multimedia processing, more specifically to thematic grouping of program segments.

### BACKGROUND

Television broadcasting is a linear medium that is temporally delivered. With advances in technology, such as video cassette recorders and digital video recorders (DVR), television viewers have been able to change the temporal nature of television broadcasting.

DVRs may record or store television programming content onto a hard drive, for instance. Also, DVRs have the ability to skip to previous or next chapters through a remote control button, for instance.

Often programs are recorded as a whole by the DVR. Sometimes users want to view a particular segment of the program, e.g., just the sports news. The user may use fast forwarding or rewinding buttons to find the particular segment. However, this may be time consuming, and the user may inadvertently skip the segment during the navigation process.

### BRIEF DESCRIPTION OF DRAWINGS

An example embodiment is illustrated by way of example and not limitation in the figures of the accompanying drawings, in which like references indicate similar elements and in which:

FIG. 1 illustrates an Internet Protocol Television system environment in which one embodiment may be implemented.

FIG. 2 illustrates a method of grouping together program segments having a searched-for theme according to one embodiment.

FIG. 3A illustrates an originally broadcast program having various segments according to an example embodiment.

FIG. 3B illustrates the segments of FIG. 3A rearranged in a playback mode according to an example embodiment.

FIG. 3C illustrates the segments of FIG. 3A rearranged in a second playback mode according to an example embodiment.

FIG. 4 illustrates a block diagram of a rearranged playback stream including segments from multiple programs according to an example embodiment.

FIG. 5 shows a diagrammatic representation of machine in the example form of a computer system within which a set of instructions, for causing the machine to perform any one or more of the methodologies discussed herein, may be executed.

### DETAILED DESCRIPTION

According to an aspect, there is provided a method and system to group program segments by theme. A program includes two or more different program segments, wherein each program segment is associated with at least one theme indicated by associated metadata. The program is queried to determine whether the program segments include a particular theme. Each of the program segments that have the particular theme are then grouped together.

Other features will be apparent from the accompanying drawings and from the detailed description which follows.

In the following description, for the purposes of explanation, numerous specific details are set forth in order to provide a thorough understanding of the disclosed embodiments. It will be apparent, however, to one skilled in the art that the disclosed embodiments may be practiced without some of these specific details. In other instances, well-known structures and devices are shown in block diagram form.

While embodiments are described with reference to digital video recorders, the method and apparatus described herein are equally applicable to other types of program recording or program viewing environments. While embodiments described herein refer to digital video recorders, the systems described herein may alternatively be set-top boxes, for instance, that are coupled with digital video recorders.

Example Internet Protocol Television System Environment

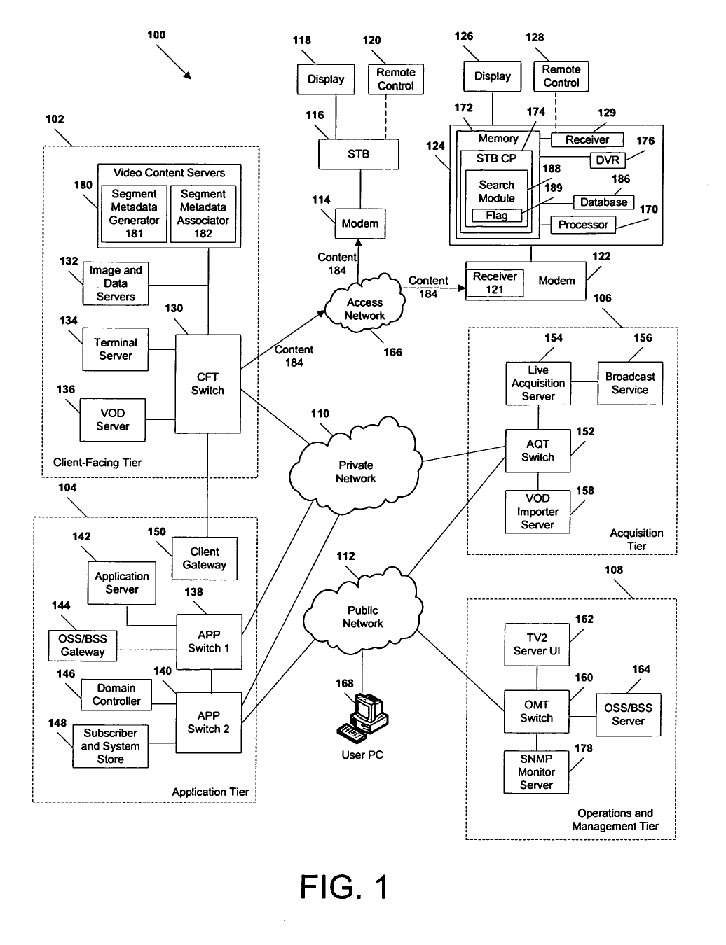

Referring to FIG. 1, an illustrative embodiment of an Internet Protocol Television (IPTV) system that may be used to provide video content is illustrated and is generally designated 100. As shown, the system 100 may include a client facing tier 102, an application tier 104, an acquisition tier 106, and an operations and management tier 108. Each tier 102, 104, 106, 108 is coupled to a private network 110; to a public network 112, such as the Internet; or to both the private network 110 and the public network 112. For example, the client-facing tier 102 may be coupled to the private network 110. Further, the application tier 104 may be coupled to the private network 110 and to the public network 112. The acquisition tier 106 may also be coupled to the private network 110 and to the public network 112. Additionally, the operations and management tier 108 may be coupled to the public network 112.

As illustrated in FIG. 1, the various tiers 102, 104, 106, 108 communicate with each other via the private network 110 and the public network 112. For instance, the client-facing tier 102 may communicate with the application tier 104 and the acquisition tier 106 via the private network 110. The application tier 104 may also communicate with the acquisition tier 106 via the private network 110. Further, the application tier 104 may communicate with the acquisition tier 106 and the operations and management tier 108 via the public network 112. Moreover, the acquisition tier 106 may communicate with the operations and management tier 108 via the public network 112. In a particular embodiment, elements of the application tier 104, including, but not limited to, a client gateway 150, may communicate directly with the client-facing tier 102.

As illustrated in FIG. 1, the client-facing tier 102 may communicate with user equipment via a private access network 166, such as an Internet Protocol Television (IPTV) access network. In an illustrative embodiment, modems, such as a first modem 114 and a second modem 122 may be coupled to the private access network 166. The client-facing tier 102 may communicate with a first representative set-top box device 116 via the first modem 114 and with a second representative set-top box device 124 via the second modem 122. Each modem 114, 122 may include a receiver, such as receiver 121 of modem 122, to receive the content data 184, for instance. The client-facing tier 102 may communicate with a large number of set-top boxes, such as the representative set-top boxes 116, 124, over a wide geographic area, such as a regional area, a metropolitan area, a viewing area, a designated market area or any other suitable geographic area, market area, or subscriber or customer group that may be supported by networking the client-facing tier 102 to numerous set-top box devices. In an illustrative embodiment, the client-facing tier, or any portion thereof, may be included at a video head-end office.

In a particular embodiment, the client-facing tier 102 may be coupled to the modems 114, 122 via fiber optic cables. Alternatively, the modems 114 and 122 may be digital subscriber line (DSL) modems that are coupled to one or more network nodes via twisted pairs, and the client-facing tier 102 may be coupled to the network nodes via fiber-optic cables. Each set-top box device 116, 124 may process data received via the private access network 166, via an IPTV software platform, such as Microsoft® TV IPTV Edition.

Additionally, the first set-top box device 116 may be coupled to a first external display device 118, such as a first television monitor, and the second set-top box device 124 may be coupled to a second external display device 126, such as a second television monitor. Moreover, the first set-top box device 116 may communicate with a first remote control 120, and the second set-top box device may communicate with a second remote control 128.

In an example, non-limiting embodiment, each set-top box device 116, 124 may receive content data 184, which may include video content and/or audio content or portions, from the client-facing tier 102 via the private access network 166. The content data 184 may be associated with at least one program, such as a broadcast program itself.

The data may include program content data associated with the at least one program. In some instances, the content data 184 may include metadata corresponding to the program content data. The metadata may include at least one tag, e.g., a theme, describing the associated program content. The metadata may be used to reorganize presentation of program content, based on user preference or specific user request.

The metadata corresponding to particular program segments of the broadcast program may be generated using a segment metadata generator 181 of video content servers 180 of the client-facing tier 102. The generated metadata may be associated with the particular program segment using a segment metadata associator 182. Additionally or alternatively to the content servers 180, metadata may be generated, associated, and provided by an outside database, the device 116, 124, and/or a user of the device 116, 124, in other embodiments not shown.

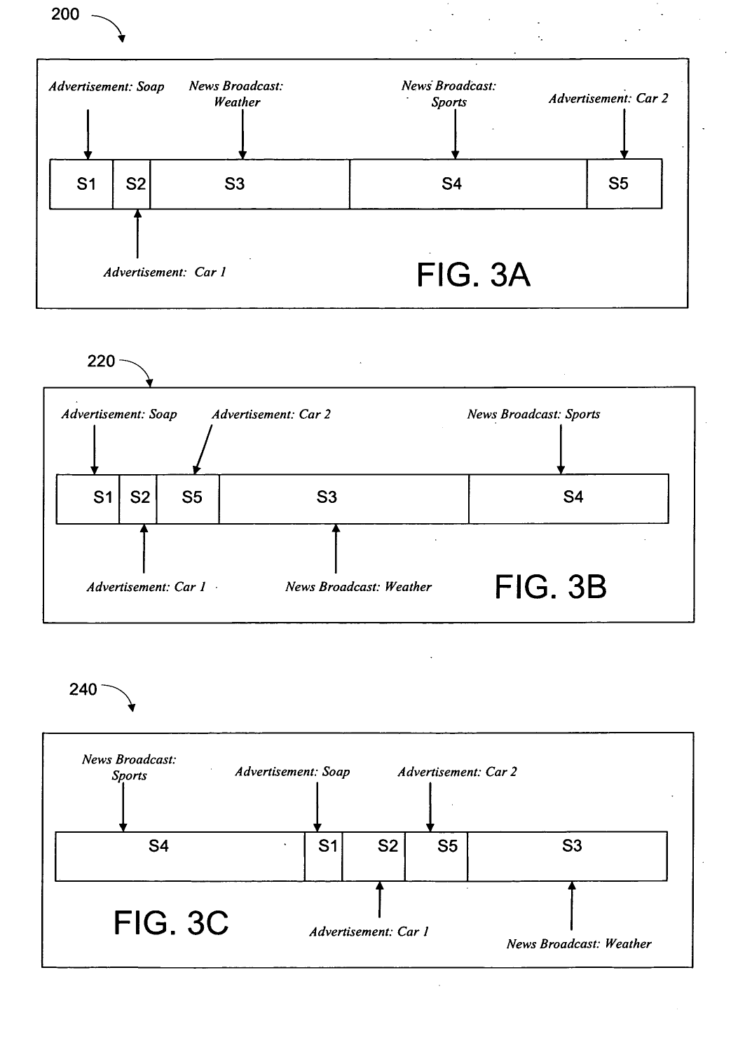

Each broadcast program may have one or more program segments, as described in more detail with regard to FIG. 3A. Each program segment may have metadata with one or more themes, such that the program segments may be reorganized by metadata. In an embodiment, the program may have more than two different program segments. In an additional embodiment, the program may have two or more different program segments, other than advertisement segments. The different program segments may be rearranged in a playback or recording mode. For example, the different program segments may be grouped together by theme in a playback mode or in a recording mode.

The set-top boxes 116, 124 may transmit the content 184 to an external display device, such as the display devices 118, 126.

Further, the set-top box devices 116, 124 may each include a STB processor, such as STB processor 170, and a STB memory device, such as STB memory 172, which is accessible to the STB processor 170. In one embodiment, a computer program, such as the STB computer program (STB CP) 174, may be embedded within the STB memory device 172.

The memory 172 may be coupled with a database 186 and the STB CP 174 may include a search module 188. The database 186 may store the program content data having the program segments, and the associated metadata. The database 186 may additionally store data associated with future television programs.

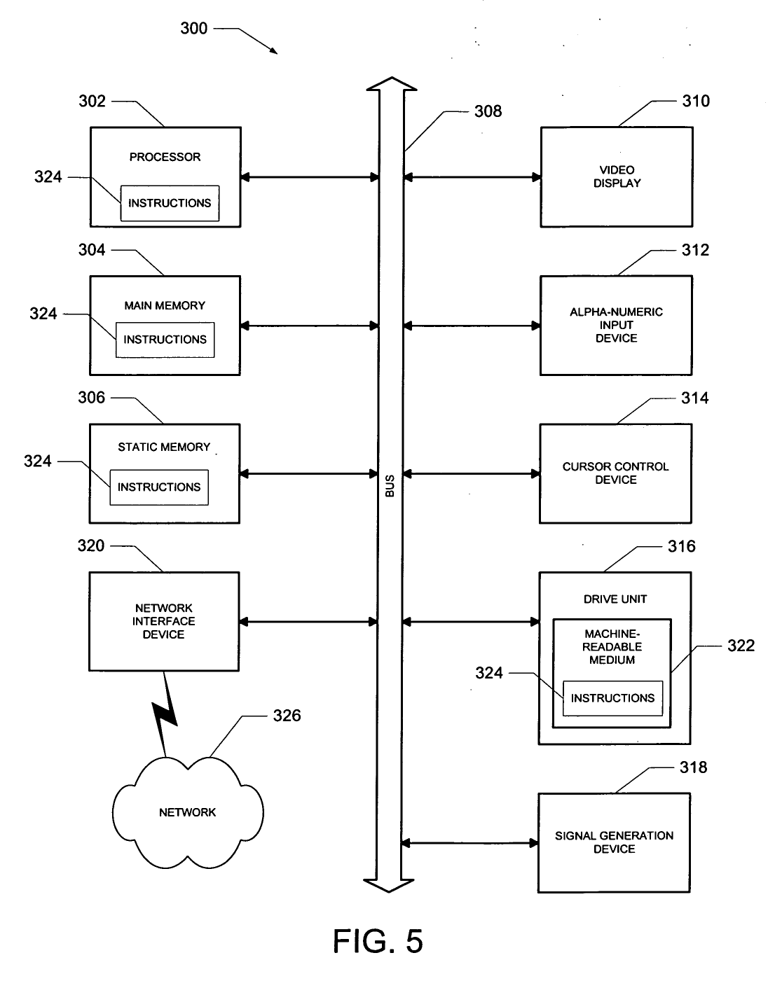

The search module 188 may be implemented in software (e.g., STB CP 174), and may accordingly appropriately configure a processor (e.g. the processor 302 of FIG. 5) to perform the various functions described below. In alternative embodiments, the search module 188 may be implemented in hardware, firmware, or a combination of software, hardware and firmware. The search module 188 operationally accesses the database 186 to search through each of the recorded program segments using the associated metadata to group together the program segments that have a searched-for theme. The grouped together program segments may be played contiguously, such that as soon as one segment ends, the next segment of the group immediately begins or such that the program segments play uninterrupted by the program segments having a theme other than the particular searched-for theme.

In additional embodiments, the search module 188 may access the database 186 to search through metadata associated with future television programs to determine which program segments are to be recorded, based on searched-for themes.

The search module 188 may include a time-sensitive flag 189 to search for the program segments broadcast within a specific time period. For example, a user may want to play each sports highlights broadcast from programs pre-recorded (e.g., on the DVR) over a previous period, which may be pre-defined by the user (See FIG. 4). In an additional embodiment, the user may want to record each sports highlights broadcast segment over a future period, such as the next 12 hour period.

Each set-top box device 116, 124 may also include a video content storage module, such as a digital video recorder (DVR) 176. In a particular embodiment, the set-top box devices 116, 124 may communicate commands received from the remote control devices 120, 128 to the client-facing tier 102 via the private access network 166.

In an illustrative embodiment, the client-facing tier 102 may include a client-facing tier (CFT) switch 130 that manages communication between the client-facing tier 102 and the private access network 166 and between the client-facing tier 102 and the private network 110. As shown, the CFT switch 130 is coupled to one or more image and data servers 132 that store still images associated with programs of various IPTV channels. The image and data servers 132 may also store data related to various channels, e.g., types of data related to the channels and to programs or video content displayed via the channels. In an illustrative embodiment, the image and data servers 132 may be a cluster of servers, each of which may store still images, channel and program-related data, or any combination thereof. The CFT switch 130 may also be coupled to a terminal server 134 that provides terminal devices with a connection point to the private network 110. In a particular embodiment, the CFT switch 130 may also be coupled to a video-on-demand (VOD) server 136 that stores or provides VOD content imported by the IPTV system 100. The client-facing tier 102 may also include one or more video content servers 180 that transmit video content requested by viewers via their set-top boxes 116, 124. In an illustrative, non-limiting embodiment, the video content servers 180 may include one or more multicast servers.

As illustrated in FIG. 1, the application tier 104 may communicate with both the private network 110 and the public network 112. The application tier 104 may include a first application tier (APP) switch 138 and a second APP switch 140. In a particular embodiment, the first APP switch 138 may be coupled to the second APP switch 140. The first APP switch 138 may be coupled to an application server 142 and to an OSS/BSS gateway 144. In a particular embodiment, the application server 142 may provide applications to the set-top box devices 116, 124 via the private access network 166, which enable the set-top box devices 116, 124 to provide functions, such as display, messaging, processing of IPTV data and VOD material, etc. In a particular embodiment, the OSS/BSS gateway 144 includes operation systems and support (OSS) data, as well as billing systems and support (BSS) data. In one embodiment, the OSS/BSS gateway may provide or restrict access to an OSS/BSS server 164 that stores operations and billing systems data.

Further, the second APP switch 140 may be coupled to a domain controller 146 that provides web access, for example, to users via the public network 112. For example, the domain controller 146 may provide remote web access to IPTV account information via the public network 112, which users may access using their personal computers 168. The second APP switch 140 may be coupled to a subscriber and system store 148 that includes account information, such as account information that is associated with users who access the system 100 via the private network 110 or the public network 112. In a particular embodiment, the application tier 104 may also include a client gateway 150 that communicates data directly with the client-facing tier 102. In this embodiment, the client gateway 150 may be coupled directly to the CFT switch 130. The client gateway 150 may provide user access to the private network 110 and the tiers coupled thereto.

In a particular embodiment, the set-top box devices 116, 124 may access the IPTV system 100 via the private access network 166, using information received from the client gateway 150. In this embodiment, the private access network 166 may provide security for the private network 110. User devices may access the client gateway 150 via the private access network 166, and the client gateway 150 may allow such devices to access the private network 110 once the devices are authenticated or verified. Similarly, the client gateway 150 may prevent unauthorized devices, such as hacker computers or stolen set-top box devices from accessing the private network 110, by denying access to these devices beyond the private access network 166.

For example, when the first representative set-top box device 116 accesses the system 100 via the private access network 166, the client gateway 150 may verify subscriber information by communicating with the subscriber and system store 148 via the private network 110, the first APP switch 138, and the second APP switch 140. Further, the client gateway 150 may verify billing information and status by communicating with the OSS/BSS gateway 144 via the private network 110 and the first APP switch 138. In one embodiment, the OSS/BSS gateway 144 may transmit a query across the first APP switch 138, to the second APP switch 140, and the second APP switch 140 may communicate the query across the public network 112 to the OSS/BSS server 164. After the client gateway 150 confirms subscriber and/or billing information, the client gateway 150 may allow the set-top box device 116 access to IPTV content and VOD content. If the client gateway 150 cannot verify subscriber information for the set-top box device 116, e.g., because it is connected to an unauthorized twisted pair, the client gateway 150 may block transmissions to and from the set-top box device 116 beyond the private access network 166.

As indicated in FIG. 1, the acquisition tier 106 includes an acquisition tier (AQT) switch 152 that communicates with the private network 110. The AQT switch 152 may also communicate with the operations and management tier 108 via the public network 112. In a particular embodiment, the AQT switch 152 may be coupled to a live acquisition server 154 that receives television or movie content, for example, from a broadcast service 156. In a particular embodiment during operation of the IPTV system, the live acquisition server 154 may acquire television or movie content. The live acquisition server 154 may transmit the television or movie content to the AQT switch 152, and the AQT switch 152 may transmit the television or movie content to the CFT switch 130 via the private network 110.

Further, the television or movie content may be transmitted to the video content servers 180, where it may be encoded, formatted, stored, or otherwise manipulated and prepared for communication to the set-top box devices 116, 124. The CFT switch 130 may communicate the television or movie content to the modems 114, 122 via the private access network 166. The set-top box devices 116, 124 may receive the television or movie content via the modems 114, 122, and may transmit the television or movie content to the display devices 118, 126. In an illustrative embodiment, video or audio portions of the television or movie content may be streamed to the set-top box devices 116, 124.

Further, the AQT switch may be coupled to a video-on-demand importer server 158 that stores television or movie content received at the acquisition tier 106 and communicates the stored content to the VOD server 136 at the client-facing tier 102 via the private network 110. Additionally, at the acquisition tier 106, the video-on-demand (VOD) importer server 158 may receive content from one or more VOD sources outside the IPTV system 100, such as movie studios and programmers of non-live content. The VOD importer server 158 may transmit the VOD content to the AQT switch 152, and the AQT switch 152, in turn, may communicate the material to the CFT switch 130 via the private network 110. The VOD content may be stored at one or more servers, such as the VOD server 136.

When user issue requests for VOD content via the set-top box devices 116, 124, the requests may be transmitted over the private access network 166 to the VOD server 136, via the CFT switch 130. Upon receiving such requests, the VOD server 136 may retrieve the requested VOD content and transmit the content to the set-top box devices 116,124 across the private access network 166, via the CFT switch 130. The set-top box devices 116, 124 may transmit the VOD content to the display devices 118, 126. In an illustrative embodiment, video or audio portions of VOD content may be streamed to the set-top box devices 116, 124.

FIG. 1 further illustrates that the operations and management tier 108 may include an operations and management tier (OMT) switch 160 that conducts communication between the operations and management tier 108 and the public network 112. In the embodiment illustrated by FIG. 1, the OMT switch 160 is coupled to a TV2 server 162. Additionally, the OMT switch 160 may be coupled to an OSS/BSS server 164 and to a simple network management protocol (SNMP) monitor server 178 that monitors network devices within or coupled to the IPTV system 100. In a particular embodiment, the OMT switch 160 may communicate with the AQT switch 152 via the public network 112.

In an illustrative embodiment, the live acquisition server 154 may transmit the television or movie content to the AQT switch 152, and the AQT switch 152, in turn, may transmit the television or movie content to the OMT switch 160 via the public network 112. In this embodiment, the OMT switch 160 may transmit the television or movie content to the TV2 server 162 for display to users accessing the user interface at the TV2 server 162. For example, a user may access the TV2 server 162 using a personal computer (PC) 168 coupled to the public network 112.

Flow Chart

The blocks of the method described below may be performed under the control of a programmed processor, such as processor 302 (FIG. 5), or the logic may be implemented and distributed among hardware, firmware, software, or a combination thereof within the device 116 and/or 124, for example.

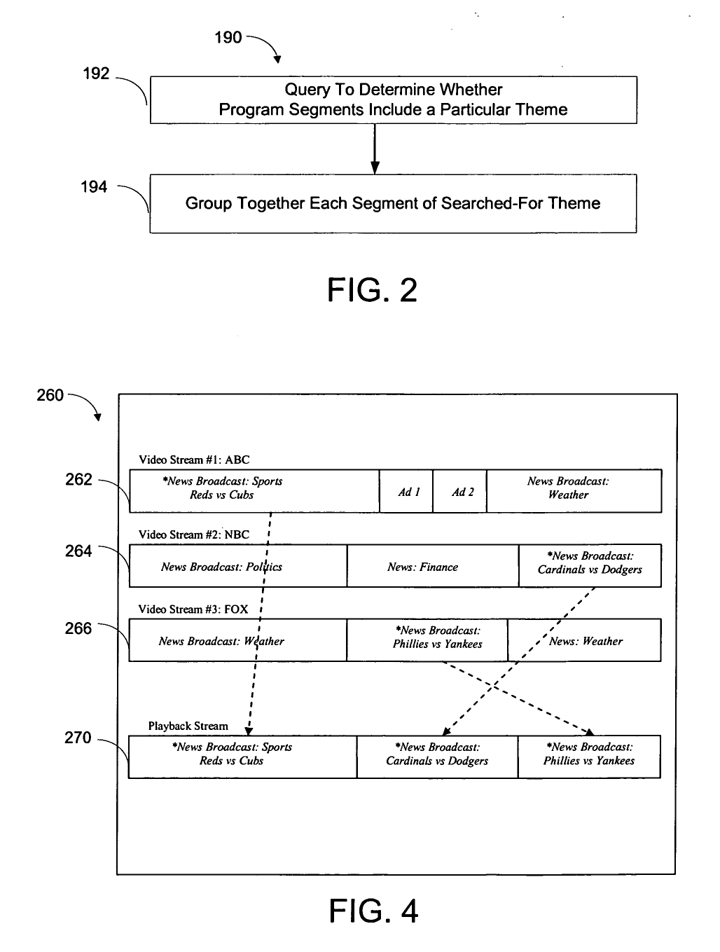

FIG. 2 illustrates a method 190 of grouping together program segments by theme according to one embodiment.

At 192, the program with segments is queried, wherein the query is to determine whether the program segments include a particular searched-for theme. The query may be based on user preferences or based on a specific user request.

At 194, segments having the searched-for theme are grouped together. The segments with the searched-for theme may be played contiguously in a playback mode. As playback occurs, the file being played back shifts at the end of each segment to the next segment that includes the searched-for theme. In other embodiments, the segments with the searched-for theme may be recorded contiguously.

In yet another embodiment, the program segments with the searched-for theme are excluded from a segment playback and/or a recording. For example, if the viewer was not interested in finance, or in weather, or in advertisements, or in politics, the viewer may exclude one or more program segments related to these themed subject matters from the playback stream. The viewer then is able to view all of the remaining content (program segments). In this instance, the viewer is specifying what they do not want to see during the playback mode. An example of this embodiment is shown in FIG. 4, where the playback stream 270 illustrates the remaining content after each excluded themed subject matter is excluded.

Example Embodiments

The programs described herein with reference to FIGS. 3A and 4, for example, may be a drama, a movie, a situation comedy, a news program, a feature presentation, a special event, a sports program, a variety show, or any other type of broadcast program group. The program content material of the programs may be divided into different program segments, including commercial groups, such as advertisement groups, for instance.

FIG. 3A illustrates an originally broadcast program having various segments, according to an example embodiment. In this instance, the program group may include a news broadcast and the time length of the program may be, e.g., 30 minutes. The program segments of the broadcast program may be news, weather, local, sports, entertainment, etc. or the program segments may each be news features, for example. Segments S1, S2, and S5 include different advertisement segments in this example.

FIG. 3A illustrates the program having two or more program segments other than advertisement segments, namely, program segments S3 and S4. In this embodiment, segments S3 and S4 include different program segments, specifically, news weather and news sports program segments, respectively. Other examples of different program segments will be apparent to those of skill in the art. The advertisement segments may include clips from future program segments, for example, or other commercial advertisements.

In addition, FIG. 3A illustrates the program having more than two program segments, each program segment being associated with at least one theme indicated by associated metadata, namely, S1, S2, S3, S4, and S5. In some embodiments, S2 and S5 have a common secondary theme (e.g., car advertisements). S1, S2, and S5 may also have a common primary theme (e.g., advertisements). S3 and S4 may have a common primary theme (e.g., News Broadcast) that may have different secondary themes (e.g., News weather and News Sports, respectively).

In between each program segment is a chapter point that enables a user to forward to a beginning of the relevant segment, which may follow another segment or an advertisement, for instance. The chapter points may be determined by a content provider, an outside database, a digital video recorder, and/or a user.

FIG. 3B illustrates the segments of FIG. 3A rearranged in a playback mode 220, according to an example embodiment. The presentation of the program segments may be reorganized based on user preference or based on a specific user request. For example, a user may specify that for every program played, each advertisement is presented at the beginning in the playback mode. The actual recorded program may remain unchanged as shown in FIG. 3A, while the playback looks like FIG. 3B.

FIG. 3C illustrates the segments of FIG. 3A rearranged in a second playback mode 240, according to an example embodiment. In this example, the user may specify that sports segments are watched first, advertisement segments second, and weather segments last. This may be based on user preference and/or specific user request. Again, the actual recorded program may remain unchanged as shown in FIG. 3A, while the playback looks like FIG. 3C. In another embodiment, the actual recorded program may resemble FIG. 3C.

FIG. 4 illustrates a block diagram 260 of a rearranged playback stream 270 including segments from multiple programs 262, 264, 266, according to an example embodiment. Multiple programs may be broadcast through the content data 184 at any given time, each with their own program content data and metadata. The search module 188 searches through each of the program segments of each of the multiple programs using the associated metadata to group together the program segments that have the searched-for theme.

In this example, segments with a common searched-for theme from multiple programs 262, 264, 266 are to be combined during playback. The metadata or tags of all available recorded (or to be recorded) video streams are matched with the request (or preference). For example, if the user searches for metadata including sports, in particular, baseball related segments, to the exclusion of other content from the multiple programs 262, 264, 266, the rearrangement of the subject matter is as shown in FIG. 4.

The actual recorded programs may remain unchanged as shown in programs 262, 264, 266, while the playback may look like stream 270. In another embodiment, the actual recorded program may resemble playback stream 270.

In an embodiment, a first means for querying a program, to search whether the program segments of the program include a particular theme, may include the search module 188, a program of the STB CP 174, or any other means within one skilled in the art to make such a query.

The first means may also be for querying multiple programs to search for the particular theme, each of the multiple programs having two or more different program segments other than advertisement segments. A second means for grouping together each of the program segments that have the particular theme may include a program of the STB CP 174, for instance, or any other means within one skilled in the art to make such a query.

Computer Architecture

FIG. 5 shows a diagrammatic representation of a machine in the example form of a computer system 300 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a digital video recorder (DVR), a personal video recorder (PVR), a personal computer (PC), a tablet PC, a set-top box (STB), a Personal Digital Assistant (PDA), a cellular telephone, a web appliance, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 300 includes a processor 302 (e.g., a central processing unit (CPU), a graphics processing unit (GPU) or both), a main memory 304 and a static memory 306, which communicate with each other via a bus 308. The main memory 304 and/or the static memory 306 may be used to store the recorded programs and/or the look up tables.

The computer system 300 may further include a video display unit 310 (e.g., a television, a liquid crystal display (LCD) or a cathode ray tube (CRT)) on which to display broadcast or other programs, for example. The computer system 300 also includes an alphanumeric input device 312 (e.g., a keyboard or a remote control), a user interface (UI) navigation device 314 (e.g., a remote control, or a mouse), a disk drive unit 316, a signal generation device 318 (e.g., a speaker) and a network interface device 320.

The disk drive unit 316 includes a machine-readable medium 322 on which is stored one or more sets of instructions and data structures (e.g., software 324) embodying or utilized by any one or more of the methodologies or functions described herein (e.g., the software to access the look-up table in the database 186 to find the program format type corresponding with the transmitted program format code). The software 324 may also reside, completely or at least partially, within the main memory 304 and/or within the processor 302 during execution thereof by the computer system 300, the main memory 304 and the processor 302 also constituting machine-readable media.

The software 324 and/or the content data 184 from the content servers 180 may further be transmitted or received over a network 326 (e.g., a television cable provider) via the network interface device 320 (e.g., the receiver 130) utilizing any one of a number of well-known transfer protocols (e.g., broadcast transmissions, HTTP).

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies described, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

Although the present disclosure has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A system to group digital video recording program segments by theme, the system comprising:
a program having more than two program segments, each program segment being associated with at least one theme indicated by associated metadata; and
a search module to search through each of the program segments using the associated metadata to group together the program segments that have a searched-for theme.

2. The system of claim 1 wherein the program includes a recorded program, wherein playback viewing includes contiguous viewing of the grouped together program segments that have the searched-for theme and the recorded program remains unchanged during the playback viewing.

3. The system of claim 1 wherein the program segments that have the searched-for theme are excluded from a segment playback.

4. The system of claim 3 wherein the segment playback includes each of the remaining program segments after the program segments that have the searched-for theme are excluded.

5. A system to group digital video recording program segments by theme, the system comprising:
a database including a program having two or more different program segments other than advertisement segments, each program segment being associated with at least one theme indicated by associated metadata; and
a search module to search through each of the program segments using the associated metadata and to group together the program segments that have a searched-for theme.

6. The system of claim 5 wherein the program includes one of a program previously recorded using a digital video recorder and a program to be recorded using the digital video recorder.

7. The system of claim 6 wherein the program includes the previously recorded program, the system further comprising a display device to view the recorded program in a playback viewing wherein the program segments with the searched-for theme are contiguously viewed, wherein the recorded program remains unchanged during the playback viewing.

8. The system of claim 6 wherein the program includes the program to be recorded, wherein the program segments with the searched-for theme are recorded contiguously using the digital video recorder.

9. The system of claim 6 wherein the program includes the program to be recorded, wherein the program segments of the program are recorded in an original format using the digital video recorder, the system further comprising a display device to view the recorded program in a playback viewing wherein the program segments with the searched-for theme are grouped together during the playback viewing.

10. The system of claim 5 wherein there are multiple programs, each having two or more different program segments other than advertisement segments, the search module to search through each of the program segments of each of the multiple programs using the associated metadata to group together the program segments that have the searched-for theme.

11. The system of claim 5 wherein the search module includes a time-sensitive flag to search for the program segments broadcast within a specific time period.

12. The system of claim 5 wherein a tag separating the program segments within the program is designated by at least one from a group of content provider, an outside database, a digital video recorder, and a user.

13. The system of claim 5 wherein the at least one theme indicated by the associated metadata of each program segment is provided by at least one from a group including a content provider, an outside database, a digital video recorder, and a user.

14. The system of claim 5 wherein the program segments that have the searched-for theme are excluded from a segment playback.

15. A method to group digital video recording program segments by theme, the method comprising:
querying a program having two or more different program segments other than advertisement segments, each program segment being associated with at least one theme indicated by associated metadata, wherein the query is to determine whether the two or more different program segments other than advertisement segments include a particular theme; and
grouping together each of the program segments that have the particular theme in a playback mode.

16. The method of claim 15 further comprising rearranging playback of the program segments, wherein the program segments having the particular theme are played uninterrupted by the program segments having a theme other than the particular theme.

17. The method of claim 15 further comprising querying multiple programs to search for the particular theme, each of the multiple programs having two or more different program segments other than advertisement segments, the search module to search through each of the program segments of each of the multiple programs using the associated metadata to group together the program segments that have the searched-for theme.

18. A system to group digital video recording program segments by theme, the system comprising:
first means for querying a program having two or more different program segments other than advertisement segments, each program segment being associated with at least one theme indicated by associated metadata, wherein the query is to search whether the two or more different program segments other than advertisement segments include a particular theme; and
second means for grouping together each of the program segments that have the particular theme in a playback mode.

19. The system of claim 18 wherein the first means is for querying multiple programs to search for the particular theme, each of the multiple programs having two or more different program segments other than advertisement segments, the first means for querying through each of the program segments of each of the multiple programs using the associated metadata to group together the program segments that have the searched-for theme.

20. A machine-readable medium having stored thereon data representing sequences of instructions to group digital video recording program segments by theme, the sequences of instructions, when executed by a machine, cause the machine to:
query a program having two or more different program segments other than advertisement segments, each program segment being associated with at least one theme indicated by associated metadata, wherein the query is to determine whether the two or more different program segments other than advertisement segments include a particular theme; and
group together each of the program segments that have the particular theme in a playback mode.

21. A system to associate thematic metadata with digital video recording program segments, the system comprising:
a segment metadata generator to generate metadata corresponding to particular program segments of a broadcast program, wherein each program segment includes the metadata with a particular theme; and
a segment metadata associator to associate the generated metadata with the particular program segments to generate metadata-segment association information, wherein the metadata-segment association information is to be delivered to a device to group the particular program segments by the theme.

22. The system of claim 21 including a content provider of the broadcast program.
